(19) United States
(12) Patent Application Publication
(10) Pub. No.: US 2024/0112037 A1
(43) Pub. Date: Apr. 4, 2024

(54) AUTOMATIC MODULATION CLASSIFICATION METHOD BASED ON DEEP LEARNING NETWORK FUSION

(71) Applicant: Yangtze Delta Region Institute of University of Electronic Science and Technology of China, Huzhou City (CN)

(72) Inventors: Shunsheng ZHANG, Huzhou City (CN); Jie HUANG, Huzhou City (CN)

(21) Appl. No.: 18/076,160

(22) Filed: Dec. 6, 2022

(30) Foreign Application Priority Data
Sep. 23, 2022 (CN) 2022111668957

(51) Int. Cl. G06N 3/091; G06F 17/15

(52) U.S. Cl. CPC G06N 3/091; G06F 17/156

(57) ABSTRACT

The present invention discloses an automatic modulation classification method based on deep learning network fusion, comprising: acquiring a WBFM sample signal within a data set RML 2016.10a, and selecting a proper threshold γ to separate a WBFM signal during a silence period; expanding a new WBFM signal to 1000 by adopting a data enhancement method, and expanding an original data set; dividing the data set expanded in the step S2 into a training set, a verification set and a test set; respectively calculating amplitude, phase and a fractional order Fourier transformation result for data in the step S3; building a multi-channel feature fusion network model composed of an LSTM network and an FPN network; performing network model training, after the end of training, inputting verification set data into a trained network model for verification, and calculating prediction accuracy; and performing parameter fine adjustment on the network model through said test set, improving prediction precision, and taking a final model as an automatic modulation classification model. The present invention enables the improvement to the average classification accuracy rate of communication signals.

### FIELD OF THE INVENTION

The invention relates to the technical field of identifying a communication signal modulation mode, in particular to an automatic modulation classification method based on deep learning network fusion.

### BACKGROUND OF THE INVENTION

Automatic Modulation Classification (AMC) is widely applied in the field of communication reconnaissance as a key step of communication signal demodulation. The traditional AMC method is mainly divided into two categories: a maximum likelihood-based recognition method and a feature extraction-based recognition method. The former gives a probability distribution, and enables the classification assignment of signals by means of a detection theory and a decision criterion. The latter is an optimal method on Bayesian estimation, but its algorithm is very complex and excessively depends on parameter estimation.

In recent years, the deep learning method has great progress in the fields of image processing, speech recognition, natural language processing and the like. Timothy J. O'shea first adopted a convolutional neural network (CNN) to identify the modulation mode of communication signals, therefor he has specially developed a RML 2016.10a data set used for identifying a communication signal modulation mode, in which on a signal-to-noise ratio (SNR) of 10 dB, an identification accuracy rate can reach 73%. Under the teaching of Timothy J. O'Shea, researchers try different deep learning methods by using an RML 2016.10 A data set to carry out AMC identification research. Due to the limitation of the data set itself, it is difficult for existing methods to effectively distinguish a Wide Band Frequency Modulation (WBFM) signal from a Double Sideband-Amplitude Modulation (DSB-AM) signal, and a Quadrature Amplitude Modulation (16 QAM) signal from a 64 QAM signal.

### SUMMARY OF THE INVENTION

Based on the deficiencies in the prior art, the present invention provides an automatic modulation classification method based on deep learning network fusion. The specific technical scheme is as follows:

An automatic modulation classification method based on deep learning network fusion, comprising the following steps:
S1, acquiring a WBFM sample signal within a RML 2016.10a data set, and selecting a proper threshold γ Γ to separate a WBFM signal during a silence period;
S2, expanding a new WBFM signal to 1000 by adopting a data enhancement method, and expanding an original data set;
S3, dividing the data set expanded in the step S2 into a training set, a verification set and a test set;
S4, respectively calculating amplitude, phase and a fractional order Fourier transformation result for data in the step S3;
S5, building a multi-channel feature fusion (MFF) network model composed of an LSTM network and an FPN network; using the training set in the step S4 as an input, which to the LSTM network is an amplitude of i^{th} data and a phase of i^{th} data, and which to the FPN network is an imaginary part of i^{th} data, a real part of i^{th} data, and a fractional order Fourier transformation result of i^{th} data;
S6, performing network model training, after the end of training, inputting verification set data into a trained network model for verification, and calculating prediction accuracy; and
S7, performing parameter fine adjustment on the network model by means of the test set to improve prediction precision, and taking a final model as an automatic modulation classification model.

Specifically, the step S1 includes the following sub steps:
selecting all data samples with a WBFM label, and normalizing the zero centers of the acquired WBFM sample signals, giving the maximum value of the instantaneous amplitude spectral density

$${γ}_{max} = max \vert {fft [ \frac{{N}_{s} \cdot A ( i )}{{\sum }_{i = 1}^{{N}_{s}} A ( i )} - 1 ]}^{2} \vert ,$$

where A(i) is an instantaneous amplitude value at each sampling time, Nₛ is the number of sampling points, fft(·) is a Fourier transformation operator, max (·) presents a maximum value; and
selecting a proper threshold γ, on γₘₐₓ>γ judging that the signal is not a WBFM signal in a silence period, then acquiring the sample signal.

Specifically, the step S2 includes the following sub step:
the modulation mode of the RML 2016.10a data set being I/Q modulation, enabling a single sample signal to be represented as xᵢ=┌I, Q┐; changing the single sample signal as xᵢ=┌I,−Q┐, xᵢ=┌−I,Q┐, xᵢ=┌−I,−Q┐, so as to expand the WBFM signal to 1000 sample data.

Specifically, the step S3 includes the following sub step:
dividing the data set expanded in the S2 to the training set as 60%, the verification set as 20% and the test set as 20%, and randomly disarranging the raining set data.

Specifically, the step S4 includes the following sub steps:
converting IQ signals into amplitude phase information with the amplitude as follows:

Aᵢ=\sqrt{Iᵢ²+Qᵢ²}
where, Iᵢ and Qᵢ represent an imaginary part of i^{th} data and a real part of i^{th} data, respectively, Aᵢ represents a amplitude of i^{th} data;
performing L2 norm normalization, where the L2 norm of an amplitude of i^{th} data is defined as:

Aₙₒᵣₘ=\sqrt{A₁²+A₂²+ . . . A_{N}²}
the amplitude after the L2 norm normalization being as follows:

$${A}^{′} = \frac{{A}_{i}}{{A}_{norm}} ;$$

a phase calculation formula being as follows:

φᵢ=arctan(Qᵢ/Iᵢ)
wherein arctan is an arctangent function;
acquiring the fractional order Fourier transformation result for data, with its calculation formula as follows:

$${X}_{p} ( u ) = \vert {F}^{p} [ s ( t ) ] \vert = \vert {\int }_{- ∞}^{+ ∞} ( {I}_{i} + {jQ}_{i} ) {K}_{p} ( t , u ) dt \vert \\ {K}_{p} ( t , u ) = \{ \begin{matrix}\sqrt{1 - j cot α} {e}^{j π [ ( {t}^{2} + {u}^{2} ) cot α - 2 tu csc α ]} , α \neq n π \\ δ ( t - u ) , α = 2 n π \\ δ ( t + u ) , α = ( 2 n + 1 ) π\end{matrix}$$

wherein F^{p} is a fractional Fourier transformation operator, s(t) is an original signal, Kₚ(t,u) is a conversion kernel, t is a time domain, u is a fractional order Fourier domain, α is a rotation angle, cot is a cotangent function, csc is a cosecant function, π is a circular constant, δ(t) is an impulse function, n is a positive integer.

Thus, completing the extraction of amplitude, phase and fractional Fourier transformation information.

Specifically, the step S5 includes the following sub step:
the input to the LSTM network being an amplitude of i^{th} data and a phase of i^{th} data, an output form the LSTM network being a dimensional feature graph; the input to the FPN network being an imaginary part of i^{th} data, a real part of i^{th} data, and a fractional order Fourier transformation result of i^{th} data.

Specifically, the step S5 includes the following sub steps:
building the LSTM network with an input layer, two LSTM layers, a Dense layer and an output layer, where an input data matrix is N×128×2, an output matrix is N×M, N is the number of samples, and M is the number of feature points; and
building the FPN network with three input layers, three Conv2d layers and two Dense layers, where an input data matrix is N×3×128×1, an output matrix is N×M×1, N is the number of samples, and M is the number of feature points.

Specifically, the LSTM network model further includes a forget gate, an input gate, an output gate and output memory information; the calculation formula of the forget gate is as follows:

f_{τ}=σ(W_{f}·[h_{τ-1},x_{τ}]+b_{f})
where W_{f} represents a forget gate weight matrix, x_{τ} represents an input matrix at a time step length τ, h_{τ-1} represents an output of a hidden layer at a previous time; b_{f} represents a forget gate deviation; sigmoid function is

$$σ ( x ) = \frac{1}{1 + {e}^{- x}} ,$$

f_{τ}∈(0,1), with e as a natural constant;
the calculation formula of the input gate is as follows:

i_{τ}=σ(Wᵢ·[h_{τ-1},x_{τ}]+bᵢ
where Wᵢ represents an input gate weight matrix, bᵢ represents an input gate deviation, i_{τ}∈(0,1);
the calculation formula of the output gate is as follows:

o_{τ}=σ(Wₒ·[h_{τ-1},x_{τ}]+bₒ)
wherein Wₒ represents an input gate weight matrix, bₒ represents an output gate deviation o_{τ}∈(0,1);
the calculation formula of the output memory information is as follows:

C_{τ}=f_{τ}*C_{τ-1}+i_{τ}*tanh(W_{Q}·[h_{τ-1},x_{τ}]+b_{Q})
wherein W_{Q} represents a memory unit weight matrix, b_{Q} represents a memory unit deviation, a hidden output at a time τ is h_{τ}=o_{τ} tanh(C_{τ}), with tanh as a hyperbolic tangent function.

Specifically, the step S6 includes the following sub steps:
in a deep learning training process, an optimizer being set to be Adam, a loss function being a cross entropy function, adopting a dynamic learning rate scheme with an initial learning rate set to 0.001;
if no reduction of the loss function of the verification set at the tenth round of training, multiplying the learning rate by a coefficient 0.8 to improve the training efficiency; and
if no reduction of the loss function of the verification set within 80 rounds of training, stopping training and saving the model.

Specifically, the cross entropy function is as follows:

loss=−Σ[pᵢ log \tilde{p}ᵢ+(1−pᵢ)log(1−\tilde{p}ᵢ)]
wherein \tilde{p}ᵢ represents a true value of a signal state, pᵢ represents a predicted value of a signal state, log represents a logarithmic operation.

The beneficial effects of the present invention are as follows:

In the present invention, data cleaning is performed by means of a judgment method and a data enhancement method, and an automatic modulation classification method based on multi-channel feature fusion is adopted, so as to enable the obtention of feature information of a sample signal, thereby improving the average classification accuracy rate of communication signals.

### BRIEF DESCRIPTION OF THE DRAWINGS

FIG. 1 is a multi-channel fusion feature (MFF) network diagram of the present invention.

FIG. 2 is a flow chart of the present invention.

FIG. 3 is a confusion matrix diagram of the present invention.

FIG. 4 is a comparison diagram of classification accuracy rates of different deep learning network models according to the present invention.

### DETAILED DESCRIPTION OF SOME EMBODIMENTS

In order to more clearly understand the technical features, purposes and effects of the present invention, we shall describe the specific embodiments of the present invention with reference to the accompanying drawings.

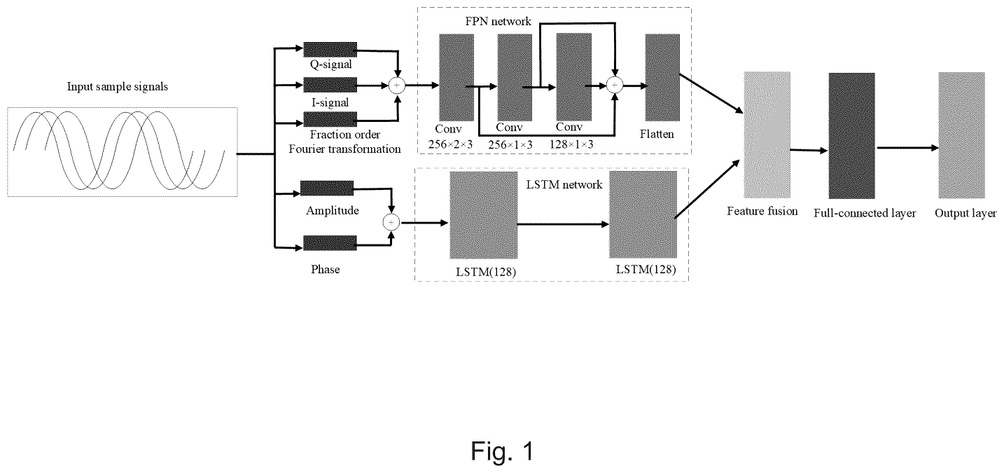

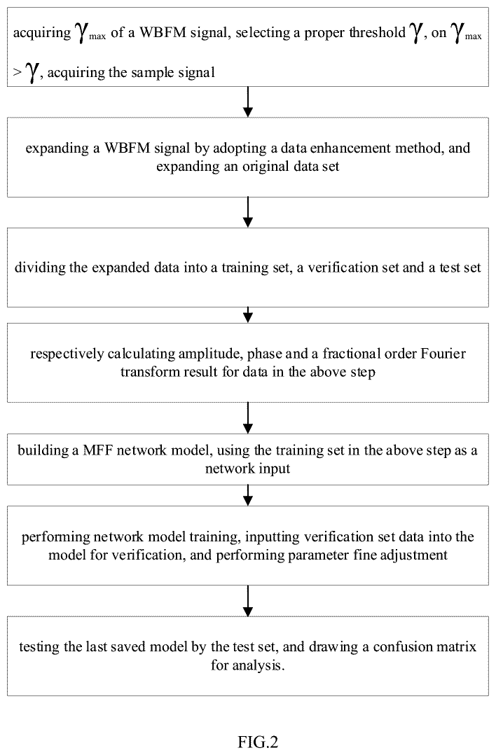

The process of the invention is as shown in FIG. 2, comprising the following steps:
S1, acquiring a WBFM sample signal within a RML 2016.10a data set, and selecting a proper threshold γ to separate a WBFM signal during a silence period;
S2, expanding a new WBFM signal to 1000 by adopting a data enhancement method, and expanding an original data set;
S3, dividing the data set expanded in the step S2 into a training set, a verification set and a test set;
S4, respectively calculating amplitude, phase and a fractional order Fourier transformation result for data in the step S3;
S5, building a multi-channel feature fusion (MFF) network model composed of an LSTM network and an FPN network; As shown in FIG. 1, using the training set in the step S4 as an input, which to the LSTM network is an amplitude of i^{th} data and a phase of i^{th} data, and which to the FPN network is an imaginary part of i^{th} data, a real part of i^{th} data, and a fractional order Fourier transformation result of i^{th} data;
S6, performing network model training, after the end of training, inputting verification set data into a trained network model for verification, and calculating prediction accuracy; and
S7, performing parameter fine adjustment on the network model by means of the test set to improve prediction precision, and taking a final model as an automatic modulation classification model.

Specifically, the step S1 includes the following sub steps:
selecting all data samples with a WBFM label, and normalizing the zero centers of the acquired WBFM sample signals, giving the maximum value of the instantaneous amplitude spectral density

$${γ}_{max} = max \vert {fft [ \frac{{N}_{s} \cdot A ( i )}{{\sum }_{i = 1}^{{N}_{s}} A ( i )} - 1 ]}^{2} \vert ,$$

where A(i) is an instantaneous amplitude value at each sampling time, Nₛ is the number of sampling points, fft(·) is a Fourier transformation operator, max (·) presents a maximum value; and
selecting a proper threshold γ, on γₘₐₓ>γ judging that the signal is not a WBFM signal in a silence period, then acquiring the sample signal.

Specifically, the step S2 includes the following sub step:
the modulation mode of the RML 2016.10a data set being I/Q modulation, enabling a single sample signal to be represented as xᵢ=┌I,Q┐; changing the single sample signal as xᵢ=┌I,−Q┐, xᵢ=┌−I,Q┐, xᵢ=┌−I,−Q┐, so as to expand the WBFM signal to 1000 sample data.

Specifically, the step S3 includes the following sub step:
dividing the data set expanded in the S2 to the training set as 60%, the verification set as 20% and the test set as 20%, and randomly disarranging the raining set data.

Specifically, the step S4 includes the following sub steps:
converting IQ signals into amplitude phase information with the amplitude as follows:

Aᵢ=\sqrt{Iᵢ²+Qᵢ²}
where, Iᵢ and Qᵢ represent an imaginary part of i^{th} data and a real part of i^{th} data, respectively, Aᵢ represents a amplitude of i^{th} data;
And then performing L2 norm normalization, where the L2 norm of an amplitude of i^{th} data is defined as:

Aₙₒᵣₘ=\sqrt{A₁²+A₂²+ . . . A_{N}²}
the amplitude after the L2 norm normalization being as follows:

$${A}^{′} = \frac{{A}_{i}}{{A}_{norm}} ;$$

a phase calculation formula being as follows:

φᵢ=arctan(Qᵢ/Iᵢ)
wherein arctan is an arctangent function;
acquiring the fractional order Fourier transformation result for data, with its calculation formula as follows:

$${X}_{p} ( u ) = \vert {F}^{p} [ s ( t ) ] \vert = \vert {\int }_{- ∞}^{+ ∞} ( {I}_{i} + {jQ}_{i} ) {K}_{p} ( t , u ) dt \vert \\ {K}_{p} ( t , u ) = \{ \begin{matrix}\sqrt{1 - j cot α} {e}^{j π [ ( {t}^{2} + {u}^{2} ) cot α - 2 tu csc α ]} , α \neq n π \\ δ ( t - u ) , α = 2 n π \\ δ ( t + u ) , α = ( 2 n + 1 ) π\end{matrix}$$

wherein F^{p} is a fractional Fourier transformation operator, s(t) is an original signal, Kₚ(t,u) is a conversion kernel, t is a time domain, u is a fractional order Fourier domain, α is a rotation angle, cot is a cotangent function, csc is a cosecant function, π is a circular constant, δ(t) is an impulse function, n is a positive integer.

Thus, completing the extraction of amplitude, phase and fractional Fourier transformation information.

Further, the specific method for building LSTM and FPN network structures in step S5 is as follows:
building the LSTM network with an input layer, two LSTM layers, a Dense layer and an output layer, where an input data matrix is N×128×2, an output matrix is N×M, N is the number of samples, and M is the number of feature points; and
building the FPN network with three input layers, three Conv2d layers and two Dense layers, where an input data matrix is N×3×128×1, an output matrix is N×M×1, N is the number of samples, and M is the number of feature points.

Specifically, the LSTM network model further includes a forget gate, an input gate, an output gate and output memory information; the calculation formula of the forget gate is as follows:

f_{τ}=σ(W_{f}·[h_{τ-1},x_{τ}]+b_{f})
where W_{f} represents a forget gate weight matrix, x_{τ} represents an input matrix at a time step length τ, h_{τ-1} represents an output of a hidden layer at a previous time; b_{f} represents a forget gate deviation; sigmoid function is

$$σ ( x ) = \frac{1}{1 + {e}^{- x}} ,$$

f_{τ}∈(0,1), with e as a natural constant;
the calculation formula of the input gate is as follows:

i_{τ}=σ(Wᵢ·[h_{τ-1},x_{τ}]+bᵢ
where Wᵢ represents an input gate weight matrix, bᵢ represents an input gate deviation, i_{τ}∈(0,1);
the calculation formula of the output gate is as follows:

o_{τ}=σ(Wₒ·[h_{τ-1},x_{τ}]+bₒ)
wherein Wₒ represents an input gate weight matrix, bₒ represents an output gate deviation o_{τ}∈(0,1);
the calculation formula of the output memory information is as follows:

C_{τ}=f_{τ}*C_{τ-1}+i_{τ}*tanh(W_{Q}·[h_{τ-1},x_{τ}]+b_{Q})
wherein W_{Q} represents a memory unit weight matrix, b_{Q} represents a memory unit deviation, a hidden output at a time τ is h_{τ}=o_{τ} tanh (Cτ), with tanh as a hyperbolic tangent function.

Further, the specific method for training model in step S6 is as follows:
in a deep learning training process, an optimizer being set to be Adam, a loss function being a cross entropy function, adopting a dynamic learning rate scheme with an initial learning rate set to 0.001; if no reduction of the loss function of the verification set at the tenth round of training, multiplying the learning rate by a coefficient 0.8 to improve the training efficiency; and if no reduction of the loss function of the verification set within 80 rounds of training, stopping training and saving the model.

In the specific implementation process, we prepare a processor of NVIDIA (NVIDIA) ORCE RTX 2070 GPU and a software platform of Pycharm so as to build a simulation experiment platform.

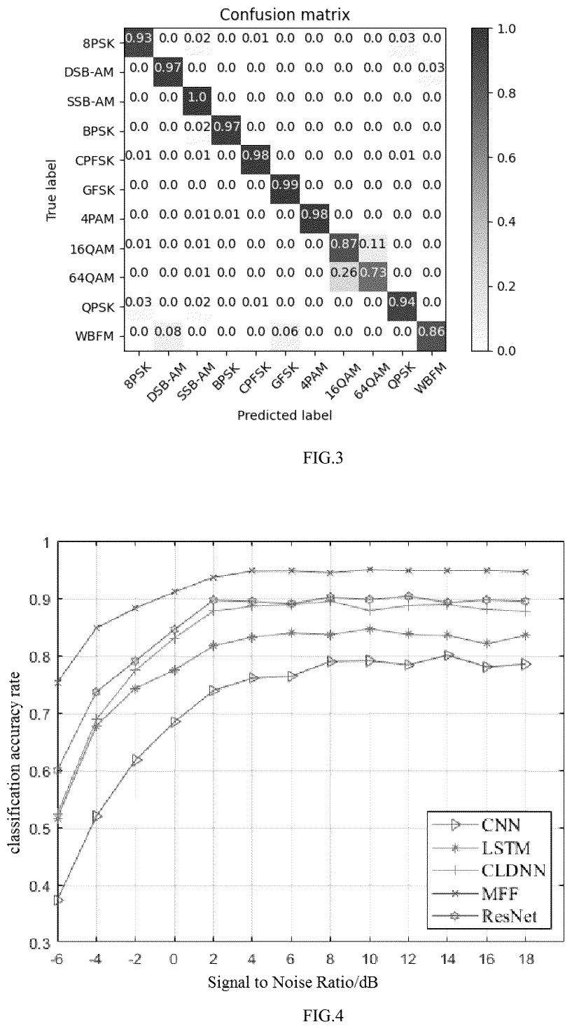

The optimal confusion matrix of the MFF network is shown in FIG. 3. It can be seen from FIG. 3 that the classification accuracy rates of 16 QAM signals and 64 QAM signals increase. Comparative experiments to the networks such as CNN, ResNet (Residual Network), LSTM and CLDNN (Convolutional Long Short-Term Deep Neural Network) are performed on the MFF network. The signal classification accuracy rates of different network models are shown in FIG. 4. It can be seen from FIG. 4 that the CNN network is poor in performance when processing time signal data with an average classification accuracy rate of only 78%. The ResNet and the CLDNN network have repeatedly made use of the feature information, but insufficient use of the feature information, with average classification accuracy rates of 90% and 88%, respectively. The average classification accuracy rate of the MFF network can reach 94% due to its full extraction of the time, space, deep and shallow features of the sample signal, thereby solving the problem of the signal confusion of 16 QAM signals and 64 QAM, and increasing the average classification accuracy rate.

In the present invention, data cleaning is performed by means of a judgment method and a data enhancement method, and an automatic modulation classification method based on multi-channel feature fusion is adopted, so as to enable the obtention of feature information of a sample signal, thereby improving the average classification accuracy rate of communication signals.

The basic principle and main features of the invention and the advantages of the invention are shown and described above. A person skilled in the art should understand that the present invention is not limited by the above embodiments, and the above embodiments and the description are merely illustrative of the principle of the present invention. Without departing from the spirit and scope of the present invention, the present invention also has various changes and improvements, and these changes and improvements fall within the scope of the present invention as claimed.

What is claimed is:

1. An automatic modulation classification method based on deep learning network fusion, comprising the following steps:
S1, acquiring a WBFM sample signal within a RML 2016.10a data set, and selecting a proper threshold γ to separate a WBFM signal during a silence period;
S2, expanding a new WBFM signal to 1000 by adopting a data enhancement method, and expanding an original data set;
S3, dividing the data set expanded in said step S2 into a training set, a verification set and a test set;
S4, respectively calculating amplitude, phase and a fractional order Fourier transformation result for data in said step S3;
S5, building a multi-channel feature fusion network model composed of an LSTM network and an FPN network;
S6, performing network model training, after the end of training, inputting verification set data into a trained network model for verification, and calculating prediction accuracy; and
S7, performing parameter fine adjustment on the network model by means of said test set to improve prediction precision, and taking a final model as an automatic modulation classification model.

2. The automatic modulation classification method based on deep learning network fusion according to claim 1, wherein said step S1 includes the following sub steps:
selecting all data samples with a WBFM label, and normalizing the zero centers of the acquired WBFM sample signals, giving the maximum value of the instantaneous amplitude spectral density
$${γ}_{max} = max \vert {fft [ \frac{{N}_{s} \cdot A ( i )}{{\sum }_{i = 1}^{{N}_{s}} A ( i )} - 1 ]}^{2} \vert ,$$
where A(i) is an instantaneous amplitude value at each sampling time, Nₛ is the number of sampling points, fft(·) is a Fourier transformation operator, max(·) presents a maximum value; and
selecting a proper threshold γ, on γₘₐₓ>γ judging that the signal is not a WBFM signal in a silence period, then acquiring said sample signal.

3. The automatic modulation classification method based on deep learning network fusion according to claim 1, wherein said step S2 includes the following sub step:
the modulation mode of said RML 2016.10a data set being I/Q modulation, enabling a single sample signal to be represented as xᵢ┌I,Q┐; changing said single sample signal as xᵢ=┌I,−Q┐, xᵢ=┌−I,Q┐, xᵢ=┌−I,−Q┐, so as to expand said WBFM signal to 1000 sample data.

4. The automatic modulation classification method based on deep learning network fusion according to claim 1, wherein said step S3 includes the following sub step:
dividing the data set expanded in said S2 to said training set as 60%, said verification set as 20% and said test set as 20%, and randomly disarranging said raining set data.

5. The automatic modulation classification method based on deep learning network fusion according to claim 1, wherein said step S4 includes the following sub steps:
converting IQ signals into amplitude phase information with the amplitude as follows:
Aᵢ=\sqrt{Iᵢ²+Qᵢ²}
where, Iᵢ and Qᵢ represent an imaginary part of i^{th} data and a real part of i^{th} data, respectively, Aᵢ represents a amplitude of i^{th} data;
performing L2 norm normalization, where the L2 norm of an amplitude of i^{th} data is defined as:
Aₙₒᵣₘ=\sqrt{A₁²+A₂²+ . . . A_{N}²}
the amplitude after said L2 norm normalization being as follows:
$${A}^{′} = \frac{{A}_{i}}{{A}_{norm}} ;$$
a phase calculation formula being as follows:
φᵢ=arctan(Qᵢ/Iᵢ)
wherein arctan is an arctangent function;
acquiring said fractional order Fourier transformation result for data, with its calculation formula as follows:
$${X}_{p} ( u ) = \vert {F}^{p} [ s ( t ) ] \vert = \vert {\int }_{- ∞}^{+ ∞} ( {I}_{i} + {jQ}_{i} ) {K}_{p} ( t , u ) dt \vert \\ {K}_{p} ( t , u ) = \{ \begin{matrix}\sqrt{1 - j cot α} {e}^{j π [ ( {t}^{2} + {u}^{2} ) cot α - 2 tu csc α ]} , α \neq n π \\ δ ( t - u ) , α = 2 n π \\ δ ( t + u ) , α = ( 2 n + 1 ) π\end{matrix}$$
wherein F^{p} is a fractional Fourier transformation operator, s(t) is an original signal, Kₚ(t,u) is a conversion kernel, t is a time domain, u is a fractional order Fourier domain, α is a rotation angle, cot is a cotangent function, csc is a cosecant function, π is a circular constant, δ(t) is an impulse function, n is a positive integer.

6. The automatic modulation classification method based on deep learning network fusion according to claim 1, wherein said step S5 includes the following sub step:
said input to said LSTM network being an amplitude of i^{th} data and a phase of i^{th} data, an output form said LSTM network being a dimensional feature graph; said input to said FPN network being an imaginary part of i^{th} data, a real part of i^{th} data, and a fractional order Fourier transformation result of i^{th} data.

7. The automatic modulation classification method based on deep learning network fusion according to claim 1, wherein said step S5 includes the following sub steps:
building said LSTM network with an input layer, two LSTM layers, a Dense layer and an output layer, where an input data matrix is N×128×2, an output matrix is N×M, N is the number of samples, and M is the number of feature points; and
building said FPN network with three input layers, three Conv2d layers and two Dense layers, where an input data matrix is N×3×128×1, an output matrix is N×M×1, N is the number of samples, and M is the number of feature points.

8. The automatic modulation classification method based on deep learning network fusion according to claim 1, wherein said LSTM network model further includes a forget gate, an input gate, an output gate and output memory information; the calculation formula of said forget gate is as follows:
f_{τ}=σ(W_{f}·[h_{τ-1},x_{τ}]+b_{f})
where W_{f} represents a forget gate weight matrix, x_{τ} represents an input matrix at a time step length τ, h_{τ-1} represents an output of a hidden layer at a previous time; b_{f} represents a forget gate deviation; sigmoid function is
$$σ ( x ) = \frac{1}{1 + {e}^{- x}} ,$$
f_{τ}∈(0, 1), with e as a natural constant;
the calculation formula of said input gate is as follows:
i_{τ}=σ(Wᵢ·[h_{τ-1},x_{τ}]+bᵢ
where Wᵢ represents an input gate weight matrix, bᵢ represents an input gate deviation, i_{τ}∈(0,1);
the calculation formula of said output gate is as follows:
o_{τ}=σ(Wₒ·[h_{τ-1},x_{τ}]+bₒ)
wherein Wₒ represents an input gate weight matrix, bₒ represents an output gate deviation o_{τ}∈(0,1);
the calculation formula of said output memory information is as follows:
C_{τ}=f_{τ}*C_{τ-1}+i_{τ}*tanh(W_{Q}·[h_{τ-1},x_{τ}]+b_{Q})
wherein W_{Q} represents a memory unit weight matrix, b_{Q} represents a memory unit deviation, a hidden output at a time τ is h_{τ}=o_{τ} tanh(C_{τ}), with tanh as a hyperbolic tangent function.

9. The automatic modulation classification method based on deep learning network fusion according to claim 1, wherein said step S6 includes the following sub steps:
in a deep learning training process, an optimizer being set to be Adam, a loss function being a cross entropy function, adopting a dynamic learning rate scheme with an initial learning rate set to 0.001;
if no reduction of the loss function of said verification set at the tenth round of training, multiplying said learning rate by a coefficient 0.8 to improve the training efficiency; and
if no reduction of the loss function of said verification set within 80 rounds of training, stopping training and saving the model.

10. The automatic modulation classification method based on deep learning network fusion according to claim 9, wherein said cross entropy function is as follows:
loss=−Σ[pᵢ log \tilde{p}ᵢ+(1−pᵢ)log(1−\tilde{p}ᵢ)]
wherein \tilde{p}ᵢ represents a true value of a signal state, pᵢ represents a predicted value of a signal state, log represents a logarithmic operation.
